(19) United States
(12) Patent Application Publication
(10) Pub. No.: US 2026/0164464 A1
(43) Pub. Date: Jun. 11, 2026

(54) CONTENTION RESOLUTION FOR NON-TERRESTRIAL NETWORK

(71) Applicant: NOKIA TECHNOLOGIES OY, Espoo (FI)

(72) Inventors: Ping YUAN, Beijing (CN); Chunli WU, Beijing (CN); Samuli Heikki TURTINEN, Ii (FI)

(21) Appl. No.: 18/707,640

(22) PCT Filed: Nov. 8, 2021
(86) PCT No.: PCT/CN2021/129322

§ 371 Date: May 6, 2024

(51) Int. Cl. H04W 74/0833; H04W 72/23

(52) U.S. Cl. CPC H04W 74/0833; H04W 72/23

(57) ABSTRACT

Embodiments of the present disclosure relate to devices, methods, apparatuses and computer readable storage media of contention resolution for the NTN. The method comprises determining whether an event has occurred, the event comprising a transmission of a message associated with a random access procedure has been performed after a previous transmission of the message, or an uplink grant associated with the message has been received after the previous transmission; and determining a contention resolution failure based on the determination on the event when a timer for monitoring a downlink control channel between a second device and the first device is expired. In this way, the issue of false declaration of contention resolution failure upon contention resolution timer expiry can be solved and the network blind scheduling for MSG3 retransmission can be achieved.

### FIELD

Embodiments of the present disclosure generally relate to the field of telecommunication and in particular to devices, methods, apparatuses and computer readable storage media of contention resolution for Non-Terrestrial Network (NTN).

### BACKGROUND

The 3rd Generation Partnership Project (3GPP) has started New Radio (NR) on NTN WI in release 17. To avoid the waste of power consumption of the User Equipment (UE), a timer for Physical Downlink Control Channel (PDCCH) monitoring may not be started immediately after the uplink (UL) transmission is initiated, because the Round Trip Time (RTT) may be very long for NTN.

### SUMMARY

In general, example embodiments of the present disclosure provide a solution of contention resolution for the NTN.

In a first aspect, there is provided a first device. The first device comprises at least one processor; and at least one memory including computer program codes; the at least one memory and the computer program codes are configured to, with the at least one processor, cause the first device at least to determine whether an event has occurred, the event comprising a transmission of a message associated with a random access procedure has been performed after a previous transmission of the message, or an uplink grant associated with the message has been received after the previous transmission; and determine a contention resolution failure based on the determination on the event when a timer for monitoring a downlink control channel between a second device and the first device is expired.

In a second aspect, there is provided a method. The method comprises determining whether an event has occurred, the event comprising a transmission of a message associated with a random access procedure has been performed after a previous transmission of the message, or an uplink grant associated with the message has been received after the previous transmission; and determining a contention resolution failure based on the determination on the event when a timer for monitoring a downlink control channel between a second device and the first device is expired.

In a third aspect, there is provided an apparatus comprising means for determining whether an event has occurred, the event comprising a transmission of a message associated with a random access procedure has been performed after a previous transmission of the message, or an uplink grant associated with the message has been received after the previous transmission; and means for determining a contention resolution failure based on the determination on the event when a timer for monitoring a downlink control channel between a second device and the first device is expired.

In a fourth aspect, there is provided a computer readable medium having a computer program stored thereon which, when executed by at least one processor of a device, causes the device to carry out the method according to the second aspect.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings, where

FIG. 1 illustrates an example environment in which example embodiments of the present disclosure can be implemented;

FIG. 2 shows a time diagram illustrating a process of contention resolution for the NTN according to some example embodiments of the present disclosure;

FIG. 3 shows a flowchart of an example method of contention resolution for the NTN according to some example embodiments of the present disclosure;

FIG. 4 shows a simplified block diagram of a device that is suitable for implementing example embodiments of the present disclosure; and

FIG. 5 shows a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements. These elements should not be limited by these terms. These terms are only used to distinguish functionalities of various elements. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as fifth generation (5G) systems, Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) new radio (NR) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), a relay, a low power node such as a femto, a pico, and so forth, depending on the applied terminology and technology. A RAN split architecture comprises a gNB-CU (Centralized unit, hosting RRC, SDAP and PDCP) controlling a plurality of gNB-DUs (Distributed unit, hosting RLC, MAC and PHY). A relay node may correspond to DU part of the IAB node.

The term “terminal device” refers to any end device that may be capable of wireless communication. By way of example rather than limitation, a terminal device may also be referred to as a communication device, user equipment (UE), a subscriber station (SS), a portable subscriber station, a mobile station (MS), or an access terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to Mobile Termination (MT) part of the integrated access and backhaul (IAB) node (a.k.a. a relay node). In the following description, the terms “terminal device”, “communication device”, “terminal”, “user equipment” and “UE” may be used interchangeably.

Although functionalities described herein can be performed, in various example embodiments, in a fixed and/or a wireless network node, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

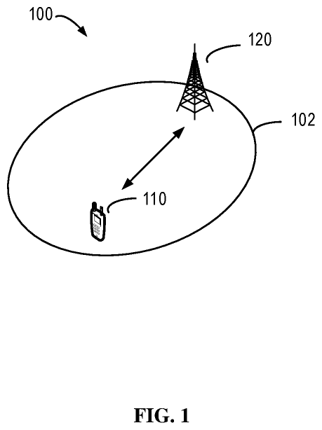

FIG. 1 shows an example communication network 100 in which embodiments of the present disclosure can be implemented. As shown in FIG. 1, the communication network 100 may comprise a terminal device 110 (hereinafter may also be referred to as a UE 110 or a first device 110). The communication network 100 may further comprise a network device 120 (hereinafter may also be referred to as a gNB 120 or a second device 120). In a case where the communication network 100 refers to a NTN, the network device 120 or segment of network device 120 can be considered as being located in a satellite. The network device 120 can manage a cell 102. The terminal device 110 and the network device 120 can communicate with each other in the coverage of the cell 102.

It is to be understood that the number of network devices and terminal devices shown in FIG. 1 is given for the purpose of illustration without suggesting any limitations. The communication network 100 may include any suitable number of network devices and terminal devices.

Currently, it has been agreed that the RTT between the UE and the gNB (UE-gNB RTT) is introduced to the starting of several timers for NTN so that the UE only needs to start monitoring the PDCCH after the RTT.

Furthermore, it has been agreed that of a Message 3 (MSG3) transmitted on a NTN, the ra-ContentionResolutionTimer is started and the ra-ContentionResolutionTimer is restarted at each Hybrid Automatic Repeat reQuest (HARQ) retransmission in the first symbol after the end of the MSG3 transmission plus the UE-gNB RTT estimated by the UE.

Since the UE-gNB RTT is introduced, it is possible that after a MSG3 retransmission, the contention resolution timer started by previous MSG3 (re)transmission might expire before it is restarted after the RTT, which might lead to unintended declaration of contention resolution failure. The UE may then perform reattempt with preamble transmission or declare RA failure if maximum attempts reached. In this situation, the UE may stop monitoring the PDCCH after the expiry of the contention resolution timer and therefore the information transmitted from the gNB may be missed before a further contention resolution timer starts.

The solution of the present disclosure proposes a mechanism of contention resolution failure determination. In this solution, the UE may determine whether an event has occurred, the event comprising a transmission of a message associated with a random access procedure has been performed after a previous transmission of the message, or an uplink grant associated with the message has been received after the previous transmission. Then the UE may determine a contention resolution failure based on the determination on the event at the time point when a timer for monitoring a downlink control channel between a second device and the first device is expired. In this way, the issue of false declaration of contention resolution failure upon contention resolution timer expiry can be solved and the network blind scheduling for MSG3 retransmission can be achieved.

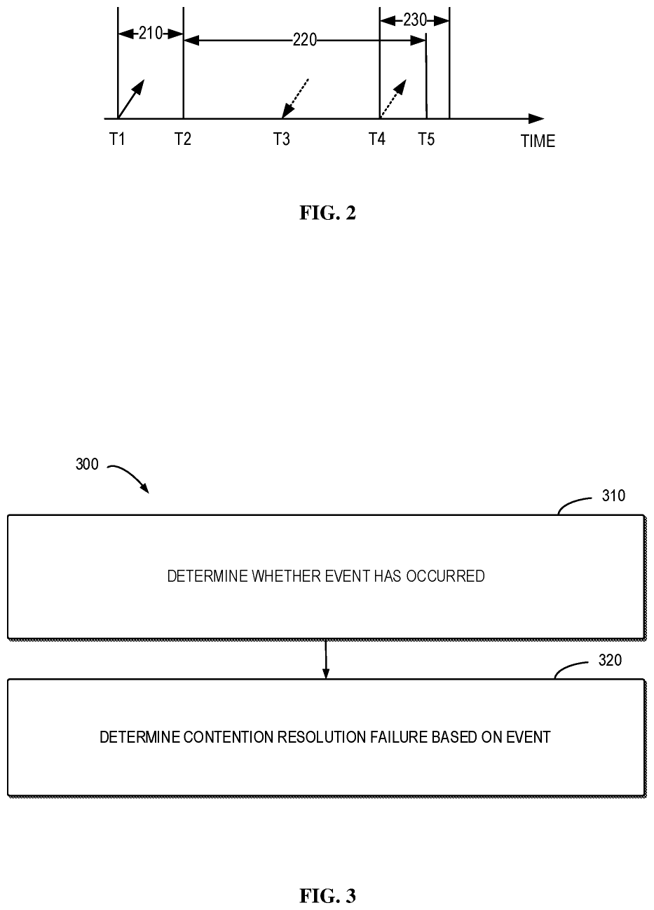

Principle and implementations of the present disclosure will be described in detail below with reference to FIG. 2, which shows a time diagram illustrating a process 200 of contention resolution for the NTN according to some example embodiments of the present disclosure. For the purpose of discussion, the process 200 will be described with reference to FIG. 1. The process 200 may involve the UE 110 and the gNB 120.

Now the reference is made to FIG. 2. At time point T1, the UE 110 may transmit a MSG3 in a random access procedure. Transmission of MSG3 at T1 maybe an initial transmission or a retransmission of MSG3. As mentioned above, since a UE-gNB RTT 210 is introduced, a contention resolution timer may be started after the UE-gNB RTT 210, i.e., at the time point T2. Within the duration 220 of the contention resolution timer, the UE 110 may monitor the PDCCH for UL grant from the gNB 120. The UL grant may be associated with the MSG3 retransmission.

The contention resolution timer will be expired at the time point T5. Before the expiry of the contention resolution timer, the UE 110 may determine whether an uplink grant is received after the transmission of the MSG3, i.e., after the time point T1, or whether a further transmission of the MSG3 is performed. In some example embodiments, the further transmission of the MSG3 may be referred to as a retransmission of the MSG3.

If an uplink grant is received after the transmission of the MSG3, for example, at the time point T3, or the further transmission of the MSG3 is performed, for example, at the time point T4, the UE 110 may determine that no contention resolution failure has occurred at the time point when the timer expires, i.e., at the time point T5, and therefore the UE 110 may keep monitoring the PDCCH after the expiry of the contention resolution timer.

In some example embodiments, if an uplink grant is received after the transmission of the MSG3 or a retransmission of the MSG3 is performed, the UE 110 may keep monitoring the PDCCH after the expiry of the contention resolution timer. In some example embodiments, the UE 110 may monitor the PDCCH also during the estimated UE-gNB RTT 230 even though the contention resolution timer is not yet running. In some other example embodiments, the UE 110 may monitor PDCCH only after UE-gNB RTT when the contention solution timer is started or restarted.

In some example embodiments, a new timer can be introduced for potential blind scheduling which is started upon the reception of PDCCH for MSG3 retransmission or after the MSG3 retransmission. The UE 110 may monitor the PDCCH also during the time duration of the new timer. Unlike contention resolution timer, the expiry of this new timer may not lead to declaration of contention resolution failure. The UE 110 may stop monitoring the PDCCH upon expiry of this new timer. With the new timer, the contention resolution timer can be stopped upon the PDCCH reception for MSG3 retransmission or MSG3 transmission without impacting blind scheduling of the gNB 120.

It is to be understood that the new timer may also be associated with other behaviours for PDCCH monitoring at UE 110 other than the reception of PDCCH for MSG3 retransmission or after the MSG3 retransmission.

In some example embodiments, an example representing the possible impaction of the proposed mechanism on the specification may be shown as below.

TABLE 1
possible impaction on the specification

| | |
|---|---|
| 1> | if ra-ContentionResolutionTimer expires and no MSG3 has been |

transmitted after the start of the ra-ContentionResolutionTimer:

2> discard the TEMPORARY_C-RNTI;
2> consider the Contention Resolution not successful.

In some example embodiments, another example representing the possible impaction of the proposed mechanism on the specification may be shown as below.

TABLE 2
possible impaction on the specification

| | |
|---|---|
| 1> | if ra-ContentionResolutionTimer expires and UE-gNB RTT timer is |
| | not running: |
| | 2> discard the TEMPORARY_C-RNTI; |
| | 2> consider the Contention Resolution not successful. |

In some example embodiments, a further example representing the possible impaction of the proposed mechanism on the specification may be shown as below.

TABLE 3
possible impaction on the specification

| | |
|---|---|
| 1> | if ra-ContentionResolutionTimer expires and no PDCCH addressed |

to TC-RNTI indicating uplink grant for a MSG3 retransmission is received
after the start of the ra-ContentionResolutionTimer:

2> discard the TEMPORARY_C-RNTI;
2> consider the Contention Resolution not successful.

With the solution of the present disclosure, the issue of false declaration of contention resolution failure upon contention resolution timer expiry can be solved and the network blind scheduling for MSG3 retransmission can be achieved.

FIG. 3 shows a flowchart of an example method 300 of contention resolution for the NTN according to some example embodiments of the present disclosure. The method 300 can be implemented at the first device 110 as shown in FIG. 1. For the purpose of discussion, the method 300 will be described with reference to FIG. 1.

At 310, the first device determines whether an event has occurred, the event comprising a transmission of a message associated with a random access procedure has been performed after a previous transmission of the message, or an uplink grant associated with the message has been received after the previous transmission.

At 320, the first device determines a contention resolution failure based on the determination on the event when a timer for monitoring a downlink control channel between a second device and the first device is expired.

In some example embodiments, if the first device determines that the event has occurred, the first device may determine that no contention resolution failure has occurred at the time point when the timer expires.

In some example embodiments, the first device may keep monitoring the downlink control channel after the expiry of the timer.

In some example embodiments, if the first device determines that the message has been retransmitted, the first device may keep monitor the downlink control channel during a round trip time between the first device and the second device before a further timer monitoring the downlink control channel starts.

In some example embodiments, the first device may keep monitor the downlink control channel based on a further timer, the further timer being associated with one of a reception of the uplink grant or a retransmission of the message.

In some example embodiments, the first device may start a further timer associated with one of a reception of the uplink grant or a retransmission of the message while terminating the timer and keep monitoring the downlink control channel within a duration of the further timer.

In some example embodiments, the message is Message 3 in the random access procedure.

In some example embodiments, the first device comprises a terminal device and the second device comprises a network device.

In some example embodiments, an apparatus capable of performing the method 300 (for example, implemented at the UE 110) may comprise means for performing the respective steps of the method 300. The means may be implemented in any suitable form. For example, the means may be implemented in a circuitry or software module.

In some example embodiments, the apparatus comprises means for determining whether an event has occurred, the event comprising a transmission of a message associated with a random access procedure has been performed after a previous transmission of the message, or an uplink grant associated with the message has been received after the previous transmission; and means for determining a contention resolution failure based on the determination on the event when a timer for monitoring a downlink control channel between a second device and the first device is expired.

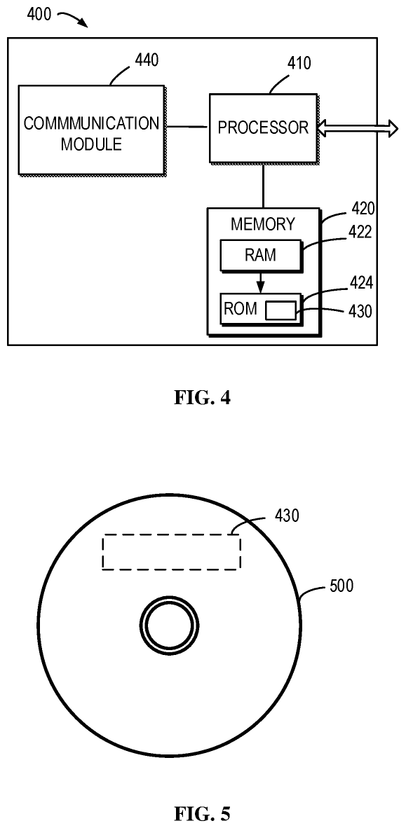

FIG. 4 is a simplified block diagram of a device 400 that is suitable for implementing embodiments of the present disclosure. The device 400 may be provided to implement the communication device, for example the UE 110 as shown in FIG. 1. As shown, the device 400 includes one or more processors 410, one or more memories 440 coupled to the processor 410, and communication modules 440 coupled to the processor 410.

The communication module 440 is for bidirectional communications. The communication module 440 has one or more communication interfaces to facilitate communication with one or more other modules or devices. The communication interfaces may represent any interface that is necessary for communication with other network elements. In some example embodiments, the communication module 440 may include at least one antenna.

The processor 410 may be of any type suitable to the local technical network and may include one or more of the following: general purpose computers, special purpose computers, microprocessors, digital reference signal processors (DSPs) and processors based on multicore processor architecture, as non-limiting examples. The device 400 may have multiple processors, such as an application specific integrated circuit chip that is slaved in time to a clock which synchronizes the main processor.

The memory 420 may include one or more non-volatile memories and one or more volatile memories. Examples of the non-volatile memories include, but are not limited to, a Read Only Memory (ROM) 424, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 422 and other volatile memories that will not last in the power-down duration.

A computer program 430 includes computer executable instructions that are executed by the associated processor 410. The program 430 may be stored in the ROM 420. The processor 410 may perform any suitable actions and processing by loading the program 430 into the RAM 420.

The embodiments of the present disclosure may be implemented by means of the program 430 so that the device 400 may perform any process of the disclosure as discussed with reference to FIGS. 2 to 3. The embodiments of the present disclosure may also be implemented by hardware or by a combination of software and hardware.

In some embodiments, the program 430 may be tangibly contained in a computer readable medium which may be included in the device 400 (such as in the memory 420) or other storage devices that are accessible by the device 400. The device 400 may load the program 430 from the computer readable medium to the RAM 422 for execution. The computer readable medium may include any types of tangible non-volatile storage, such as ROM, EPROM, a flash memory, a hard disk, CD, DVD, and the like. FIG. 5 shows an example of the computer readable medium 500 in form of CD or DVD. The computer readable medium has the program 430 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, device, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 300 as described above with reference to FIG. 3. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing device, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, device or processor to perform various processes and operations as described above. Examples of the carrier include a reference signal, computer readable medium, and the like.

The computer readable medium may be a computer readable reference signal medium or a computer readable storage medium. A computer readable medium may include but not limited to an electronic, magnetic, optical, electromagnetic, infrared, or semiconductor system, device, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-16. (canceled)

17. A first device comprising:
at least one processor; and
at least one memory including computer program codes;
the at least one memory and the computer program codes are configured to, with the at least one processor, cause the first device at least to:
determine whether a physical downlink control channel (PDCCH) addressed to a temporary cell radio network temporary identifier, indicating an uplink grant for a retransmission of a message has been received after a start of a random access contention resolution timer for monitoring the PDCCH between a second device and the first device, wherein the message is a Message 3 of a random access procedure; and
when the random access contention resolution timer is expired, in accordance with a determination that the uplink grant for the retransmission of the Message 3 has not been received after the start of the random access contention resolution timer, discard the temporary cell radio network temporary identifier and consider a contention resolution not successful.

18. The first device of claim 17, wherein the at least one memory and the computer program codes are configured to, with the at least one processor, cause the first device to:
in accordance with a determination that the uplink grant for the retransmission of the Message 3 has been received after the start of the random access contention resolution timer, determine that no contention resolution failure has occurred when the random access contention resolution timer expires.

19. The first device of claim 18, wherein the at least one memory and the computer program codes are configured to, with the at least one processor, cause the first device to:
keep monitoring the PDCCH after the expiry of the random access contention resolution timer.

20. The first device of claim 17, wherein the at least one memory and the computer program codes are configured to, with the at least one processor, cause the first device to:
start a further timer associated with a reception of the uplink grant while terminating the random access contention resolution timer; and
keep monitoring the PDCCH within a duration of the further timer.

21. The first device of claim 17, wherein the first device comprises a terminal device and the second device comprises a network device.

22. The first device of claim 17, wherein the random access contention resolution timer is started in a first symbol after the end of the Message 3 transmission plus a round trip time (RTT) between the first device and the second device.

23. The first device of claim 17, wherein the Message 3 is transmitted on a non-terrestrial network (NTN).

24. A method comprising:
determining, by a first device, whether a physical downlink control channel (PDCCH) addressed to a temporary cell radio network temporary identifier indicating an uplink grant for a retransmission of a message has been received after a start of a random access contention resolution timer for monitoring the PDCCH between a second device and the first device, wherein the message is a Message 3 of a random access procedure; and
when the random access contention resolution timer is expired, in accordance with a determination that the uplink grant for the retransmission of the Message 3 has not been received after the start of the random access contention resolution timer, discarding the temporary cell radio network temporary identifier and considering a contention resolution not successful.

25. The method of claim 24, wherein the method comprises:
in accordance with a determination that the uplink grant for the retransmission of the Message 3 has been received after the start of the random access contention resolution timer, determining that no contention resolution failure has occurred when the random access contention resolution timer expires.

26. The method of claim 25, wherein the method comprises:
keeping monitoring the PDCCH after the expiry of the random access contention resolution timer.

27. The method of claim 24, wherein the method comprises:
starting a further timer associated with a reception of the uplink grant while terminating the random access contention resolution timer; and
keeping monitoring the PDCCH within a duration of the further timer.

28. The method of claim 24, wherein the first device comprises a terminal device and the second device comprises a network device.

29. The method of claim 24, wherein the random access contention resolution timer is started in a first symbol after the end of the Message 3 transmission plus a round trip time (RTT) between the first device and the second device.

30. The method of claim 24, wherein the Message 3 is transmitted on a non-terrestrial network (NTN).

31. A non-transitory computer readable medium comprising program instructions for causing an apparatus to perform at least the method of claim 24.
